(19) United States
(12) Patent Application Publication
(10) Pub. No.: US 2016/0284381 A1
(43) Pub. Date: Sep. 29, 2016

(54) Systems and Methods for Quick Decision Editing of Media Content

(71) Applicant: CyberLink Corp., Shindian City (TW)

(72) Inventor: Wei-Sheng Yang, New Taipei City (TW)

(21) Appl. No.: 15/078,084

(22) Filed: Mar. 23, 2016

Related U.S. Application Data
(60) Provisional application No. 62/137,919, filed on Mar. 25, 2015.

(51) Int. Cl. G11B 27/034; G11B 27/038; G11B 27/28; G11B 27/34; G06F 17/30; G06K 9/00

(52) U.S. Cl. CPC G11B 27/034; G06F 17/30247; G06F 17/30784; G06K 9/00228; G11B 27/28; G11B 27/34; G11B 27/038

(57) ABSTRACT

A media editing device is configured to implement an adaptive user interface for facilitating image editing. Digital content is retrieved by the media editing device, and the digital content is analyzed. A determination is made on where one or more target attributes are exhibited by the digital content, where target attributes are grouped into different categories, and the different categories have corresponding editing tools. Based on identification of at least one target attribute in the digital content, at least one suggested editing tool in at least one category corresponding to the identified at least one target attribute is retrieved. At least one toolbar in the user interface is populated with the retrieved at least one suggested editing tool.

### CROSS-REFERENCE TO RELATED APPLICATION

This application claims priority to, and the benefit of, U.S. Provisional Patent Application entitled, “Systems and Methods for Quick Decision Editing of Media Content,” having Ser. No. 62/137,919, filed on Mar. 25, 2015, which is incorporated by reference in its entirety.

### TECHNICAL FIELD

The present disclosure generally relates to multimedia content and more particularly, to systems and methods for quick decision editing of media content.

### BACKGROUND

As smartphones and other mobile devices have become ubiquitous, people have the ability to take pictures and videos virtually any time. Furthermore, with an ever-growing amount of content available to consumers through the Internet and other sources, consumers have access to a vast amount of digital content. With existing media editing tools, users can manually edit digital images or videos to achieve a desired effect or style. However, while many media editing tools are readily available, the editing process can be complex and time-consuming for the casual user.

### SUMMARY

Briefly described, one embodiment, among others, is a method implemented in a media editing device for editing an image. The method comprises retrieving digital content and analyzing content of the digital content. The method further comprises searching for a plurality of target attributes in the digital content, the plurality of target attributes being grouped into different categories, the different categories having corresponding editing tools. Based on identification of at least one target attribute in the digital content, at least one suggested editing tool in at least one category corresponding to the identified at least one target attribute is retrieved. The method further comprises populating at least one toolbar in the user interface with the retrieved at least one suggested editing tool.

Another embodiment is a system that comprises a memory comprising logic and a processor coupled to the memory. The processor is configured by the logic to retrieve digital content and analyze the digital content. The processor is further configured to search for a plurality of target attributes in the digital content, the plurality of target attributes being grouped into different categories, the different categories having corresponding editing tools. Based on identification of the at least one target attribute in the digital content, the processor retrieves at least one suggested editing tool in at least one category corresponding to the identified at least one target attribute. The processor is further configured to populate at least one toolbar in the user interface with the retrieved at least one suggested editing tool.

Another embodiment is a non-transitory computer-readable storage medium having instructions stored thereon, wherein when executed by a processor, the instructions configure the processor to retrieve digital content depicting at least one individual and analyze attributes of the at least one individual depicted in the digital content. The instructions further configure the processor to determine whether any of the analyzed attributes match at least one of a plurality of target attributes, the plurality of target attributes being grouped into different categories, the different categories having corresponding editing tools. Based on a match with at least one target attribute. The instructions further configure the processor to retrieve at least one suggested editing tool in at least one category corresponding to the identified at least one target attribute. The instructions further configure the processor to populate at least one toolbar in the user interface with the retrieved at least one suggested editing tool.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Various aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a media editing device implementing an adaptive user interface for facilitating image editing in accordance with various embodiments.

FIG. 2 illustrates a schematic block diagram of the media editing device in FIG. 1 in accordance with various embodiments.

FIG. 3 illustrates the process flow between the components in the media editing device of FIG. 1 in accordance with various embodiments.

FIG. 4 is a flowchart for implementing an adaptive user interface for facilitating image editing performed by the media editing device of FIG. 1 in accordance with various embodiments.

FIG. 5 illustrates how the target attributes may be grouped into various categories in accordance with various embodiments.

FIG. 6 illustrates the categories of target attributes depicted in FIG. 5 each have corresponding editing tools in accordance with various embodiments.

FIG. 7 is a flowchart further describing the operations performed by various components of the effects applicator in FIG. 1 for suggesting specific editing tools to the user based on the content of digital content in accordance with various embodiments.

FIG. 8 illustrates an example where one or more target attributes corresponding to a particular category have been identified in the content of the digital content in accordance with various embodiments.

FIG. 9 illustrates the retrieval of editing tools from different categories that are then suggested to the user in accordance with various embodiments.

FIG. 10 illustrates an example scenario where the user utilizes a subset of the suggested editing tools in accordance with various embodiments.

FIG. 11 a block diagram of a networked environment in which the adaptive construction of user interfaces may be implemented in accordance with various embodiments.

FIG. 12 illustrates how the duration of target attributes may be derived based on analyzing a user interface depicting the duration of attributes along a timeline in accordance with various embodiments.

### DETAILED DESCRIPTION

Various embodiments are disclosed for systems and methods for analyzing the content of videos or digital images and identifying target attributes for purposes of presenting suggested editing tools to the user. Based on the target attribute, a customized user interface for editing the digital content is presented to the user with the suggested editing tools. In particular, systems and methods are disclosed for analyzing the content of videos or digital images for purposes of recommending editing tools to the user. In this regard, systems and methods are described for reducing the complexity of the editing process, whereby specific editing tools are presented to the user based on the attributes of the digital content to be edited and based on the user's past usage of specific editing tools with respect to the same or similar attributes now exhibited in the current digital content being edited. As described in more detail below, the media editing device 102 may be further configured to track the user's behavior with regards to the suggested editing tools that were actually utilized by the user in order to further customize the user interface in the future.

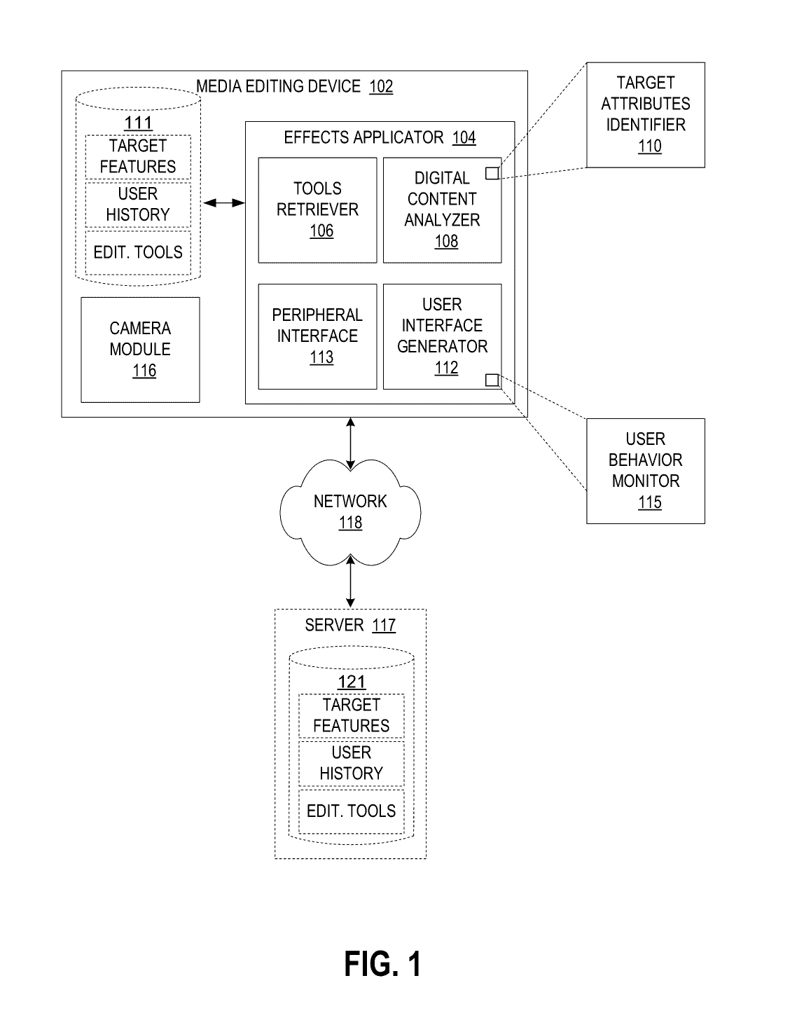

A description of a system for implementing an adaptive user interface for facilitating image editing is now described followed by a discussion of the operation of the components within the system. FIG. 1 is a block diagram of a media editing device 102 in which the adaptive construction of user interfaces disclosed herein may be implemented. The media editing device 102 may be embodied as a computing device equipped with digital content recording capabilities such as, but not limited to, a digital camera, a smartphone, a tablet computing device, a digital video recorder, a laptop computer coupled to a webcam, and so on.

An effects applicator 104 executes on a processor of the media editing device 102 and configures the processor to perform various operations, as described in more detail below. The effects applicator 104 comprises various components including a tools retriever 106, a digital content analyzer 108, a peripheral interface 113, and a user interface generator 112. The peripheral interface 113 may be configured to receive digital content from a digital recording device (e.g., digital camera) capable of capturing digital content, where the media editing device 102 is coupled to the digital recording device via a cable or other interface. The peripheral interface 113 may support any one of a number of common computer interfaces, such as, but not limited to IEEE-1394 High Performance Serial Bus (Firewire), USB, a serial connection, a Bluetooth® connection, and so on. Alternatively, the media editing device 102 may directly capture digital content via a camera module 116.

The digital content analyzer 108 configures the processor in the media editing device 102 to analyze the content of digital content to be edited. For some embodiments, the digital content analyzer 108 comprises a target attributes identifier 110 that determines attributes of the content depicted in digital content. In some embodiments, the digital content analyzer 108 may retrieve one or more target attributes from a data store 111 in the media editing device 102 for purposes of determining whether the current digital content possesses one or more of the target attributes. For some embodiments, a remote data store 121 storing the data disclosed herein in connection with the data store 111 may be implemented and maintained by a server 117 where the media editing device 102 is coupled to the server 117 via a network 118, such as the Internet or a local area network (LAN).

In accordance with various embodiments, the pre-defined target attributes may be grouped into different categories. For example, certain target attributes may be grouped in one category corresponding to facial features while other target attributes may be grouped in another category corresponding to lighting and contrast levels. The target attributes in the category corresponding to facial features may comprise for example, facial contour, eye color, nose shape, and so on.

The presence of pre-defined target attributes may be determined by analyzing the content of the digital content and/or by extracting information from metadata associated with the digital content. In accordance with various embodiments, each category of target attributes has corresponding editing tools for purposes of specifically modifying the target attributes in that category. For example, the category corresponding to facial features may include tools to modify attributes relating to the skin tone, the face shape, the hair color, and so on.

The tools retriever 106 interfaces with the digital content analyzer 108 and retrieves editing tools from the data store 111 based on the analysis performed by the digital content analyzer 108. In particular, the tools retriever 106 analyzes historical usage data in the data store 111 of one or more users and retrieves editing tools based on the analysis, as described in more detail below. The user interface generator 112 constructs a user interface comprising the suggested editing tools obtained by the tools retriever 106. The user interface generator 112 also includes a user behavior monitor 115 configured to log and store information relating to the use of editing tools by the user. In this regard, the user behavior monitor 115 analyzes usage behavior by the user in connection with specific tools for editing the image.

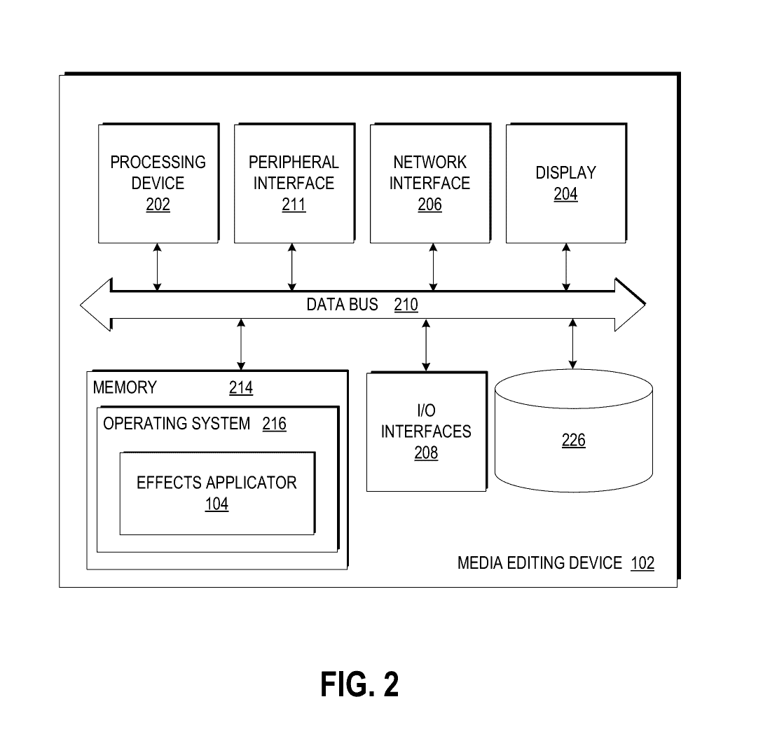

FIG. 2 illustrates a schematic block diagram of the media editing device 102 in FIG. 1. The media editing device 102 may be embodied in any one of a wide variety of wired and/or wireless computing devices, such as a desktop computer, portable computer, dedicated server computer, multiprocessor computing device, smart phone, tablet, and so forth. As shown in FIG. 2, each of the media editing device 102 comprises memory 214, a processing device 202, a number of input/output interfaces 208, a network interface 206, a display 204, a peripheral interface 113 211, and mass storage 226, wherein each of these components are connected across a local data bus 210.

The processing device 202 may include any custom made or commercially available processor, a central processing unit (CPU) or an auxiliary processor among several processors associated with the media editing device 102, a semiconductor based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system.

The memory 214 can include any one of a combination of volatile memory elements (e.g., random-access memory (RAM, such as DRAM, and SRAM, etc.)) and nonvolatile memory elements (e.g., ROM, hard drive, tape, CDROM, etc.). The memory 214 typically comprises a native operating system 216, one or more native applications, emulation systems, or emulated applications for any of a variety of operating systems and/or emulated hardware platforms, emulated operating systems, etc. For example, the applications may include application specific software which may comprise some or all the components of the media editing device 102 depicted in FIG. 1. In accordance with such embodiments, the components (such as the effects applicator 104 and accompanying components in FIG. 1) are stored in memory 214 and executed by the processing device 202. One of ordinary skill in the art will appreciate that the memory 214 can, and typically will, comprise other components which have been omitted for purposes of brevity.

Input/output interfaces 208 provide any number of interfaces for the input and output of data. For example, where the media editing device 102 comprises a personal computer, these components may interface with one or more user input/output interfaces 208, which may comprise a keyboard or a mouse, as shown in FIG. 2. The display 204 may comprise a computer monitor, a plasma screen for a PC, a liquid crystal display (LCD) on a hand held device, a touchscreen, or other display device.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

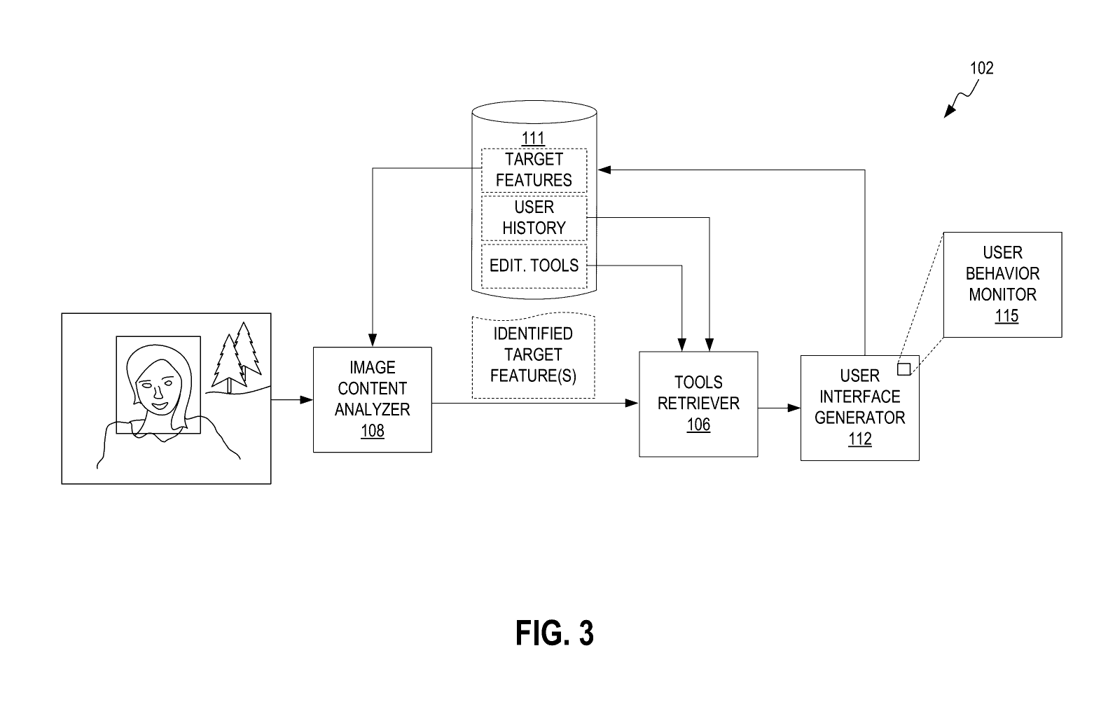

FIG. 3 illustrates the process flow between the components in the media editing device 102 of FIG. 1 in accordance with various embodiments. To begin, digital content comprising an image or video is received by the digital content analyzer 108 in the media editing device 102. The digital content analyzer 108 retrieves one or more pre-defined target attributes from the data store 111 to facilitate the identification of target attributes in the digital content. Note that in instances where the digital content comprises a video, the toolbar of suggested editing tools may vary as a function of time, depending on the attributes being exhibited at a particular time within the video. As discussed earlier, the target attributes may be categorized into different groupings.

One grouping of target attributes may comprise for example, certain facial attributes including, but not limited to, facial contour, eye color, nose shape, skin color, wrinkle, facial blemish(es), facial feature size, and so on. Another grouping of target attributes may comprise the white color balance and HSL (hue, saturation, lightness) level. Yet another grouping of target attributes may comprise a threshold lighting level, threshold contrast level, the presence of artifacts, the detection of zooming/panning motion within the digital content, the detection of shaking by the camera, a threshold level of detected motion, the presence of speech within the digital content, and so on. For target attributes associated with threshold levels (e.g., threshold lighting level), a determination is made in those instances on whether the digital content exhibits an attribute (e.g., lighting level) that falls below (or above) the particular threshold. Yet another grouping of target attributes may comprise the identity of the individual(s) depicted in the image, the location where the image was captured, the time and day when the image was captured, and so on, where such information may be stored in metadata associated with the image.

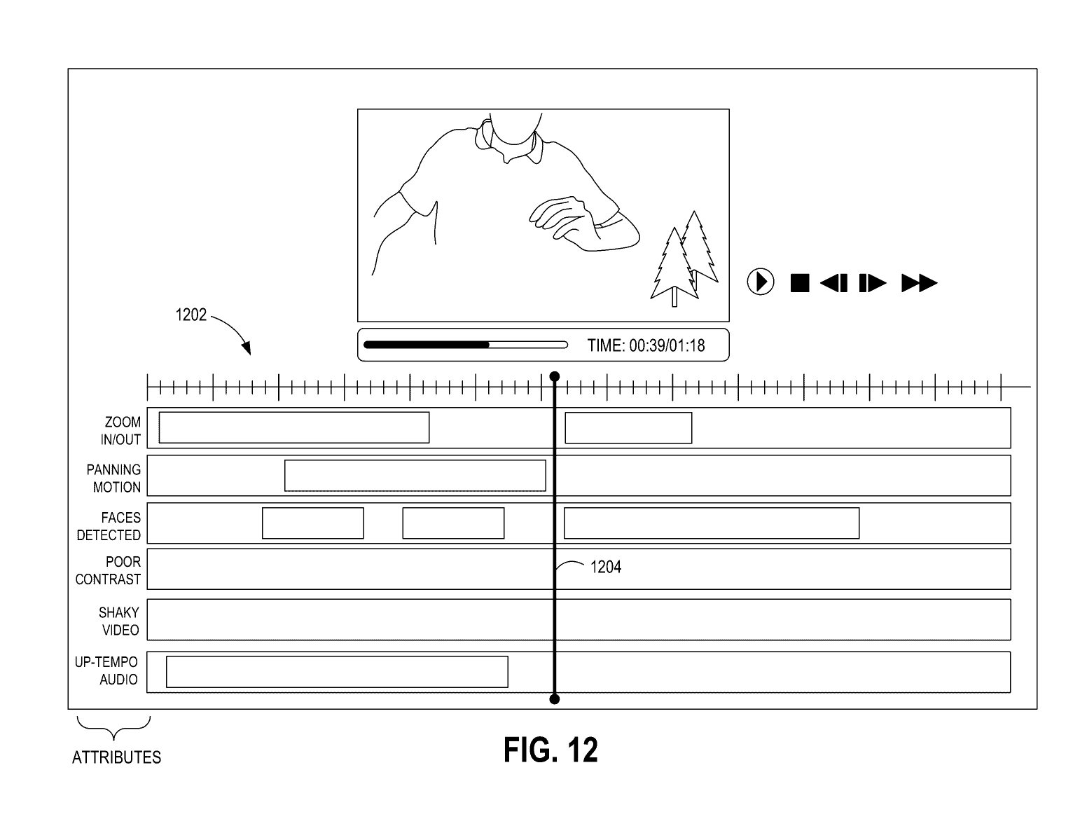

In some embodiments, the digital content analyzer 108 identifies the presence of target attributes as a function of time as certain target attributes may be exhibited throughout the duration of a video whereas other target attributes may be transient in nature. For example, the lighting level within a video may vary over time. In this regard, the user interface comprising suggested editing tools may vary as a function of time when the user is editing a video. Reference is made to FIG. 12. In some embodiments, the duration of target attributes may be derived based on analyzing another user interface depicting the duration of attributes along a timeline 1202, where a progress indicator 1204 represents the current time during playback. The boxes shown next to each attribute represents the duration in which each attribute is exhibited in the digital content. The various groupings of target attributes are maintained and updated in the data store 111 (FIG. 1).

Referring back to FIG. 3, the digital content analyzer 108 analyzes the digital image and determines whether one or more target attributes from one or more groupings are present within the digital image. For example, the digital content analyzer 108 may determine the identity of an individual depicted in the digital image based on metadata associated with the digital content and determine that other digital content depicting the same individual have been previously edited. As another example, the digital content analyzer 108 may determine that the individual depicted in the digital content has a face shape that matches a specific face shape defined by one or more of the pre-defined target attributes associated with a particular grouping. As another example, the digital content analyzer 108 may determine that the digital content has undesirable color balance or that the digital content has an undesirable white balance level based on pre-defined target attributes in a particular grouping found in the data store 111. For some embodiments, the digital content analyzer 108 may be configured to analyze an image histogram of the digital content to identify the presence of (or the absence of) one or more target attributes.

The digital content analyzer 108 forwards the identified target attributes to the tools retriever 106, which is configured to access editing tools from the data store 111. The editing tools may comprise a wide range of photo editing tools for modifying and enhancing digital content. As discussed earlier, one perceived shortcoming with conventional photo editing systems is that given the wide range of photo or video editing tools, photo or video editing can sometimes be a complex and time-consuming process, particularly if a user is relatively new to editing photos.

The tools retriever 106 analyzes the identified target attributes received from the digital content analyzer 108 and retrieves specific editing tools that will be presented to the user in order to facilitate the editing process. For example, if the digital content analyzer 108 determines the presence of a pre-defined target attribute in the digital content corresponding to an undesirable color balance level or an undesirable white balance level, the tools retriever 106 may retrieve a white balance adjustment tool for adjusting the color balance or an HSL color selection tool. Furthermore, if the identity of the user of the media editing device 102 is known, the tools retriever 106 may also retrieve user history data corresponding to the user.

The user history data stored and updated by the user behavior monitor 115 facilitates the selection of suggested editing tools by informing the tools retriever 106 which specific photo or video editing tools that particular user has utilized in the past for particular digital content. This increases the likelihood that the suggested editing tools will actually be utilized by the user. For example, the user history data may reflect that the user utilized four specific tools in the past for digital content depicting a particular individual. The tools retriever 106 takes this information into consideration when determining which editing tools to retrieve and present to the user. For some embodiments, the tools retriever 106 may be configured to examine the history data to identify editing tools that were previously retrieved (and suggested to the user) but that were ultimately not utilized by the user. In those instances, the tools retriever 106 may be configured to avoid retrieving those editing tools based on the past non-use of those editing tools in order to aid in reducing the number of suggested editing tools.

The user interface generator 112 obtains the suggested editing tools from the tools retriever 106 and constructs a user interface presenting the suggested editing tools to the user with the intent of facilitating the photo editing process. In some embodiments, the user behavior monitor 115 in the user interface generator 112 logs the editing activities of the user and stores this information as part of the user history data back into the data store 111. The user behavior monitor 115 may log, for example, which editing tools the user actually utilizes during the editing process. This may further comprise logging the user's activities reflecting whether the user utilized some or all of the suggested editing tools presented to the user to determine the accuracy in which the tools retriever 106 is retrieving tools. For example, if the user behavior monitor 115 determines that the user elected to utilize each of the suggested tools presented to the user, the user behavior monitor 115 stores this information for future use.

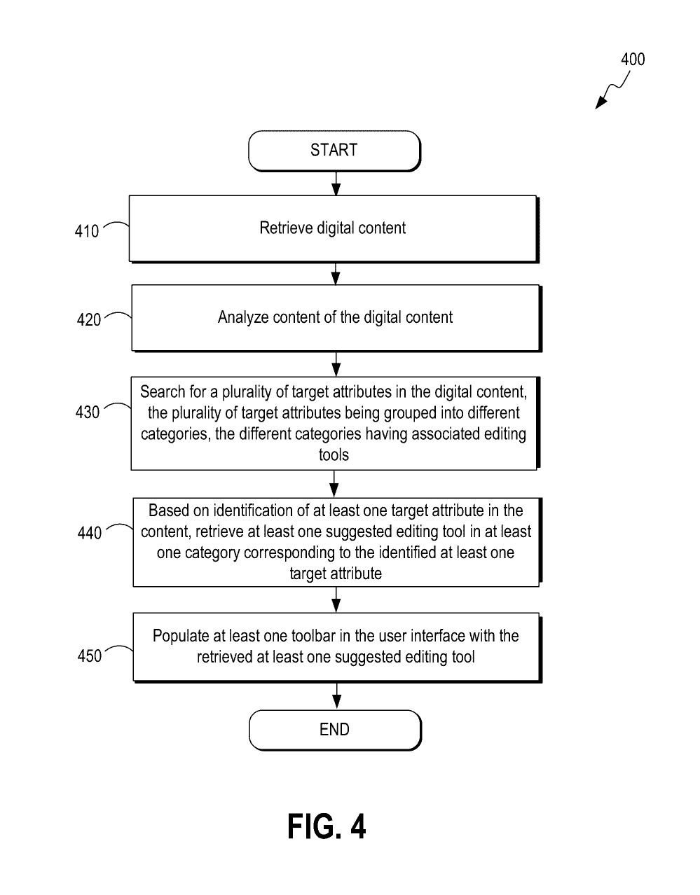

Reference is made to FIG. 4, which is a flowchart 400 in accordance with one embodiment for implementing an adaptive user interface for facilitating image editing performed by the media editing device 102 of FIG. 1. It is understood that the flowchart 400 of FIG. 4 provides merely an example of the different types of functional arrangements that may be employed to implement the operation of the various components of the media editing device 102. As an alternative, the flowchart of FIG. 4 may be viewed as depicting an example of steps of a method implemented in the media editing device 102 according to one or more embodiments.

Although the flowchart of FIG. 4 shows a specific order of execution, it is understood that the order of execution may differ from that which is depicted. For example, the order of execution of two or more blocks may be scrambled relative to the order shown. Also, two or more blocks shown in succession in FIG. 4 may be executed concurrently or with partial concurrence. It is understood that all such variations are within the scope of the present disclosure.

Beginning with block 410, the effects applicator 104 (FIG. 1) retrieves digital content and analyzes the digital content (block 420). In block 430, based on analysis of the content, the effects applicator 104 searches for target attributes in the digital content, where the target attributes are grouped into different categories and stored in a data store 111 (FIG. 1). Furthermore, each category of target attributes has one or more corresponding editing tools, where such information is also found in the data store 111.

In block 440, based on identification of at least one target attribute in the content, the effects applicator 104 retrieves at least one suggested editing tool in at least one category corresponding to the identified at least one target attribute. In block 450, the effects applicator 104 populates at least one toolbar in the user interface with the retrieved at least one suggested editing tool.

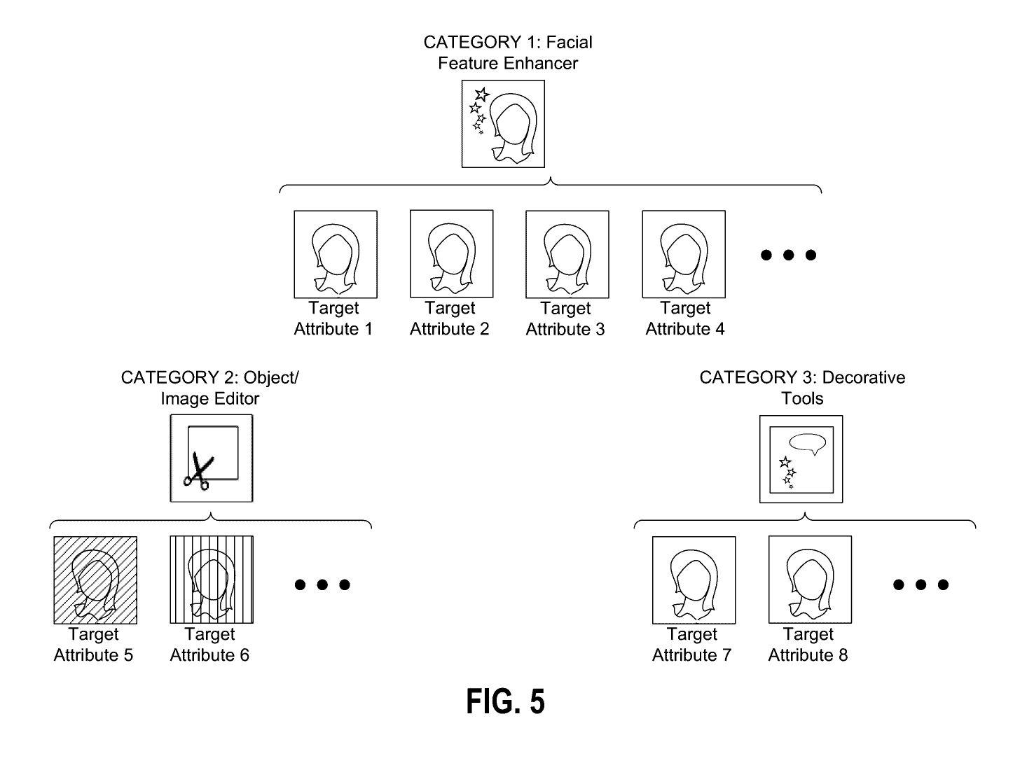

FIG. 5 illustrates how the target attributes may be grouped into various categories. In the non-limiting example shown, the media editing device 102 (FIG. 1) obtains and analyzes digital content to determine whether one or more predetermined target attributes found in one or more groupings in the data store 111 (FIG. 1) are exhibited by or associated with the digital content. In the non-limiting example shown, predetermined target attributes are grouped into various categories, where a first category of target attributes corresponds to enhancement of facial features, a second category of target attributes corresponds to object/image level enhancement, while a third category of target attributes corresponds to decorative tools for incorporating special effects into the digital content.

For some embodiments, the media editing device 102 may be configured to compare each of the pre-defined target attributes in all of the groupings in the data store 111 with attributes of the digital content. For other embodiments, the media editing device 102 may be configured to compare each of the target attributes in a subset the groupings in the data store 111 with attributes of the digital content, where the subset is determined based on the past user behavior. For example, upon determining that a particular user is utilizing the media editing device 102, the media editing device 102 retrieves information from the data store 111 relating to that particular user's past editing activities and retrieves a subset of target attributes tailored specifically for that user.

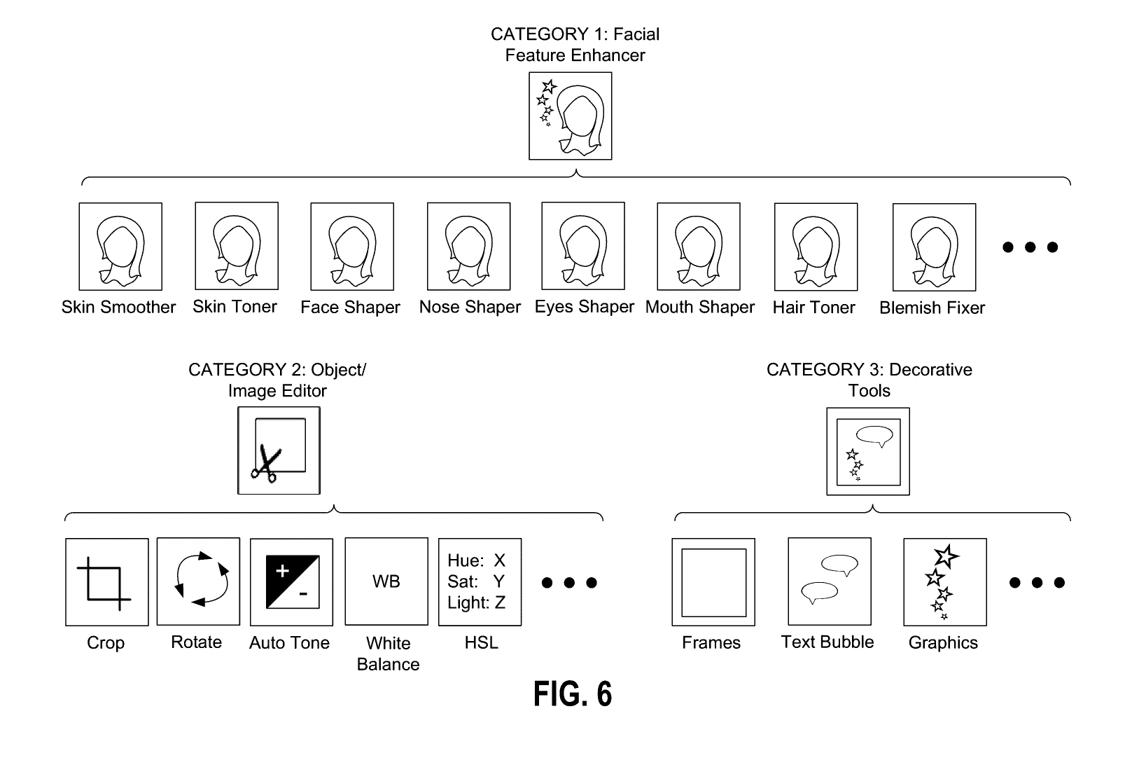

FIG. 6 illustrates the categories of target attributes depicted in FIG. 5 each have corresponding editing tools. In the non-limiting example shown, the media editing device 102 (FIG. 1) is equipped with a variety of editing tools for modifying and enhancing the appearance of digital content. As shown, the editing tools are grouped into various categories that correspond to the categories of pre-defined target attributes. As shown, the first category corresponds to enhancement of facial features and includes editing tools for modifying specific facial attributes. The second category corresponds to object/image level enhancement and includes such image editing tools as a crop tool, a rotation tool, auto tone, white balance level setter, HSL (hue, saturation, luminosity) color selection tool, and so on. The third category corresponds to decorative tools for incorporating special effects into the digital content.

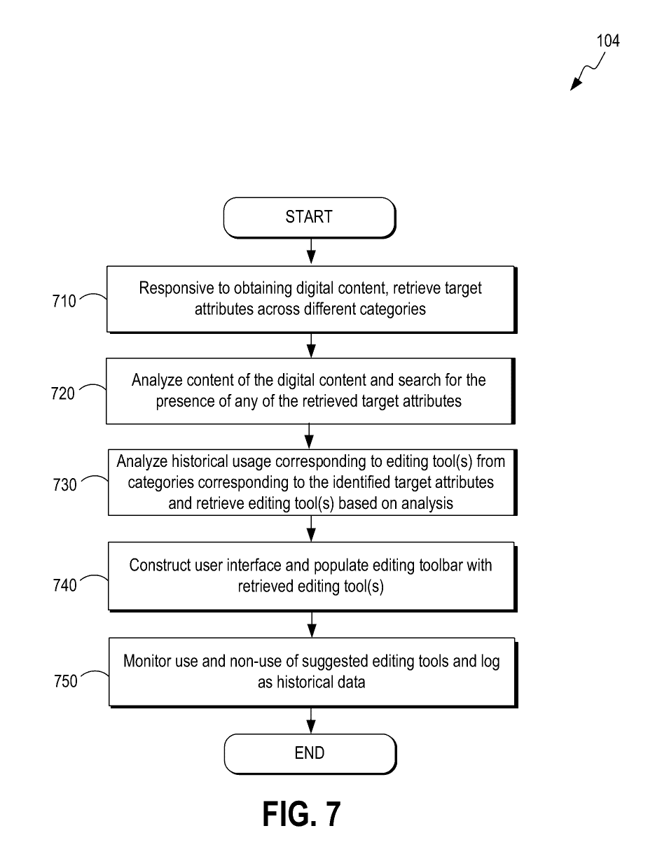

For some embodiments, the digital content analyzer 108 (FIG. 1) in the media editing device 102 determines the presence of a target attribute, and based on the analysis, the tools retriever 106 (FIG. 1) retrieves editing tools according to the category associated with the identified target attribute. To further illustrate, reference is made to FIG. 7, which depicts a flowchart in accordance with one embodiment for suggesting specific editing tools to the user based on the content of digital content. It should be emphasized that the tools retriever 106 is not limited to retrieving editing tools on a category-by-category basis and may mix and match editing tools that are then suggested to the user. In this regard, an identified target attribute may correspond to one or more categories.

It is understood that the flowchart of FIG. 7 provides merely an example of the different types of functional arrangements that may be employed to implement the operation of the various components of the effects applicator 104 (FIG. 1) executed by the media editing device 102 (FIG. 1). As an alternative, the flowchart of FIG. 7 may be viewed as depicting an example of steps of a method implemented in the media editing device 102 according to one or more embodiments.

Although the flowchart of FIG. 7 shows a specific order of execution, it is understood that the order of execution may differ from that which is depicted. For example, the order of execution of two or more blocks may be scrambled relative to the order shown. Also, two or more blocks shown in succession in FIG. 7 may be executed concurrently or with partial concurrence. It is understood that all such variations are within the scope of the present disclosure.

In block 710, in response to digital content being obtained by the media editing device 102, the effects applicator 104 accesses the data store 111 (FIG. 1) and retrieves pre-defined target features across different categories. For example, with reference back to FIG. 5, the effects applicator 104 may retrieve target attributes 1-8, which span different categories (Category 1 to Category 3).

In block 720, the target attributes identifier 110 (FIG. 1) in the effects applicator 104 analyzes the digital content and searches for the presence of any of the retrieved target attributes in the digital content. In response to identifying the presence of one or more of the retrieved target attributes in the digital content, the tools retriever 106 (FIG. 1) in the effects applicator 104 identifies the categories corresponding to the identified target attributes and analyzes historical usage data corresponding to past use of editing tools in the identified categories.

In block 730, historical data corresponding to editing tools from various categories is analyzed, and editing tools are retrieved based on the analysis. In some instances, the analysis of historical usage data assists the tools retriever 106 in retrieving a specific subset of editing tools within each of the identified categories, thereby narrowing the number of suggested editing tools. The historical usage data may contain such information as the number of instances each editing tool within a particular category has been used. The historical usage data may also contain information (e.g., date, time) reflecting when each editing tool was last used. The tools retriever 106 then retrieves suggested editing tools based on one or more pieces of data relating to historical usage of editing tools.

For some embodiments, the tools retriever 106 may determine which editing tools to retrieve based a weighted combination of different pieces of data reflected in the historical usage data. For example, the tools retriever 106 may give some weight to the fact that a particular editing tool within a particular category was most recently used. However, the tools retriever 106 may be configured to give more weight to the fact that another editing tool within the same category was used the most. Thus, the tools retriever 106 may be configured to retrieve editing tools that meet or exceed a threshold weight value. The user interface generator 112 (FIG. 1) constructs a user interface and populates an editing toolbar with the retrieved editing tools (block 740). In block 750, both the use and non-use of suggested editing tools presented to the user are monitored and stored as historical data.

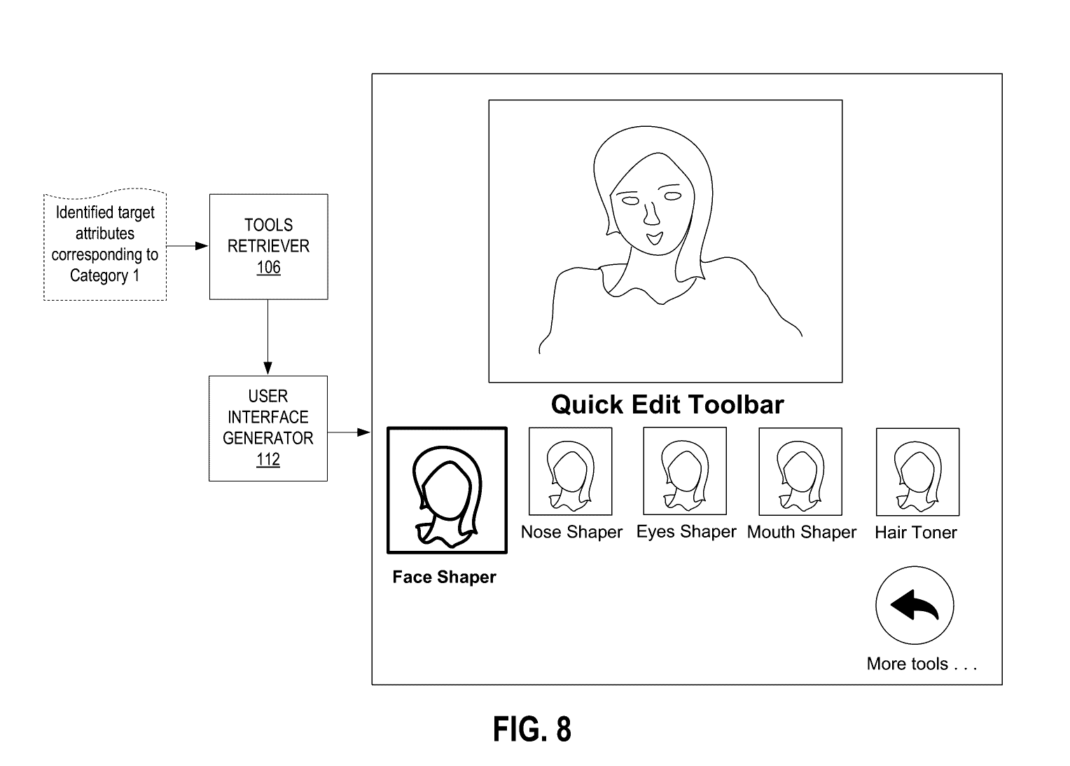

Reference is now made to FIG. 8, which illustrates an example where the presence of one or more target attributes corresponding to a particular category (i.e., Category 1 in FIG. 5) have been identified in the content of the digital content. As a result of this determination, the tools retriever 106 (FIG. 1) retrieves one or more of the editing tools associated with Category 1 (Facial Attribute Enhancer). Specifically, the tools retriever 106 may retrieve only a subset of the editing tools associated with Category 1 based on information relating to the user's past behavior in utilizing (or not utilizing) certain suggested editing tools.

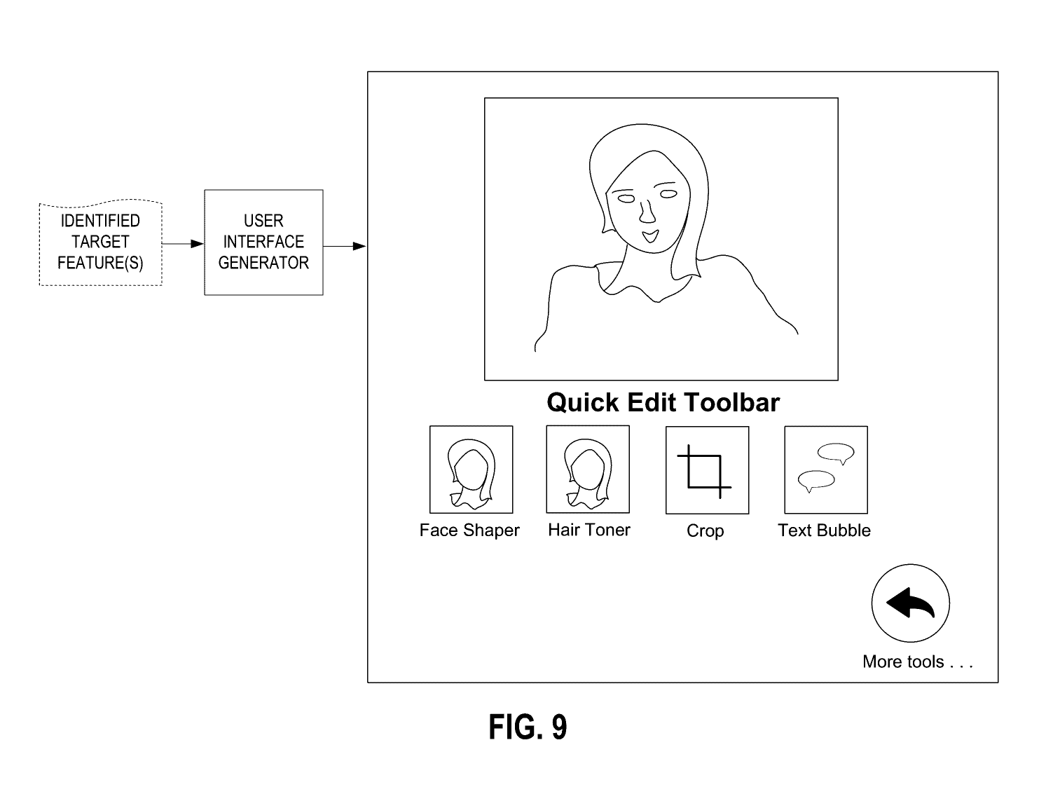

It should be emphasized that the tools retriever 106 is not limited to retrieving editing tools on a category-by-category basis and may mix and match editing tools that are then suggested to the user. For example, the tools retriever 106 may pair various facial attribute enhancer tools (e.g., hair toner) with one or more decorative tools (e.g., text bubble tool), as shown in FIG. 9. In some embodiments, a predetermining grouping of editing tools may be associated with a grouping of target attributes. For example, if the digital content analyzer 108 (FIG. 1) identifies the presence of most (or all) of the target attributes associated with a pre-determined grouping of target attributes, the tools retriever 106 may be configured to retrieve a pre-determined grouping of editing tools associated with that grouping of target attributes.

In some embodiments, the editing tools within the grouping may be sorted and presented to the user based on which editing tools are more commonly used. In this regard, certain editing tools may be prioritized over other editing tools. In the example user interface of FIG. 8, one editing tool (i.e., face shaper) is shown more prominently than the remaining editing tools. This may be based on the user's past behavior involving heavy usage of the face shaper tool. It should be emphasized that the pre-determined grouping of editing tools merely serves as a starting point, and the grouping of editing tools may be adaptively modified based on the user behavior.

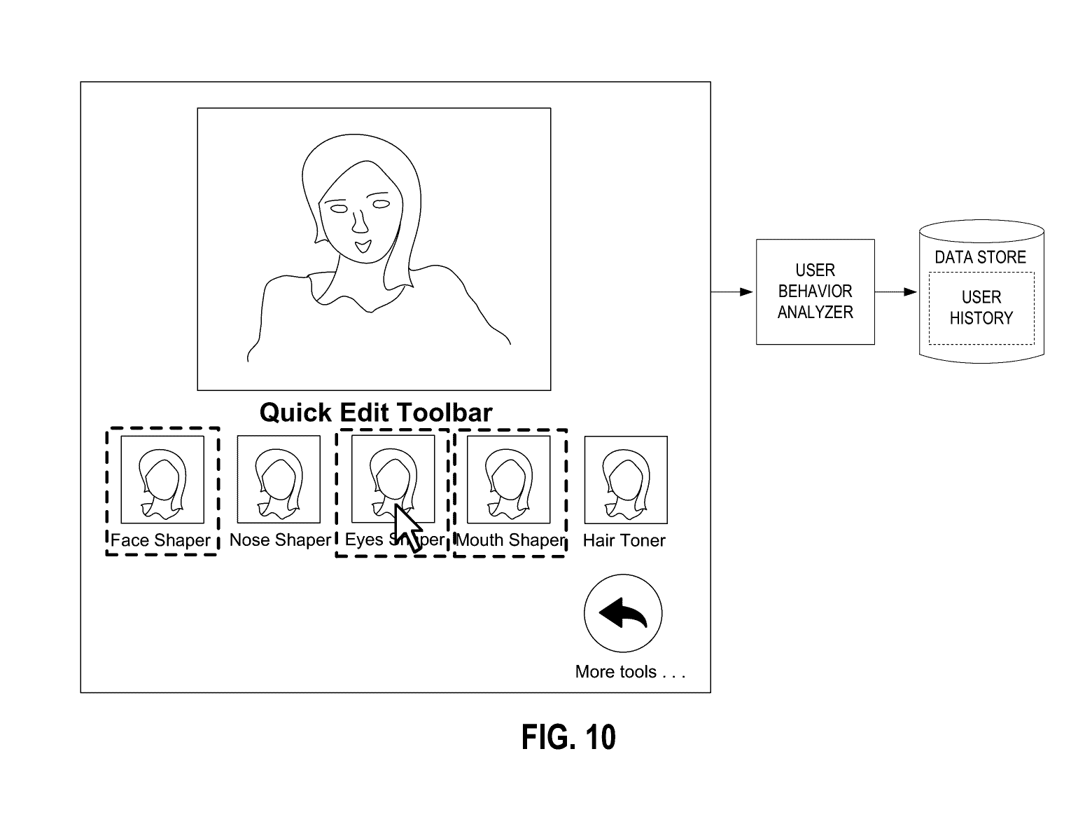

Note that as shown in the example user interfaces of FIGS. 8 and 9, the user is given the option of viewing additional editing tools if the suggested editing tools are not sufficient for achieving the effect that the user seeks to accomplish. FIG. 10 illustrates an example scenario where the user utilizes three of the five suggested editing tools (denoted by the dashed boxes). The user behavior analyzer logs this information in the data store as part of the user history data for future use. Thus, if the same user later edits another digital content that shares similar attributes (e.g., the same individual depicted in the digital content), then the tools retriever 106 may be configured to retrieve the same three editing tools that the user previously used.

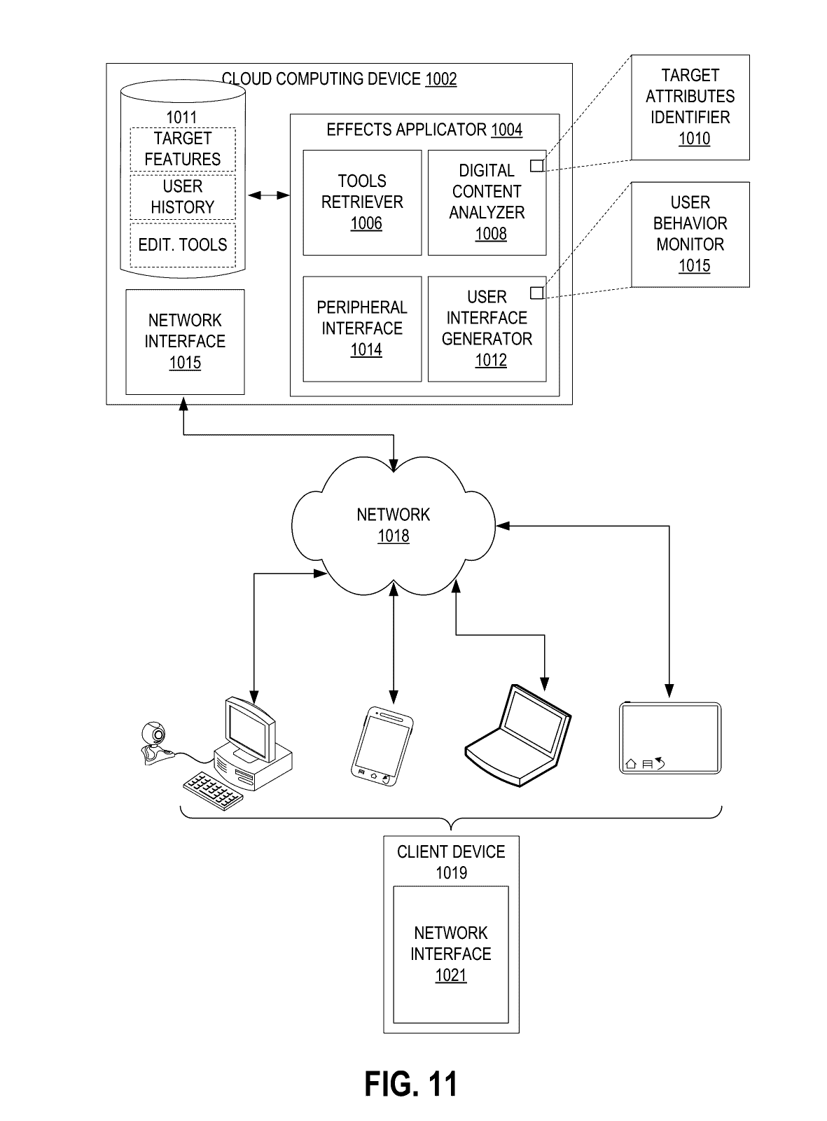

FIG. 11 illustrates a block diagram of a networked environment in which the adaptive construction of user interfaces disclosed herein may be implemented. Specifically, a networked environment is shown whereby one or more client devices are communicatively coupled via a network to a central cloud computing device that performs the functions described above in connection with the media editing device 102 (FIG. 1). In the embodiment shown, the content analysis of digital content and the construction of a user interface with suggested editing tools are performed by a cloud computing device 1002.

FIG. 12 illustrates how the duration of target attributes may be derived based on analyzing a user interface depicting the duration of attributes along a timeline. The digital content analyzer 108 identifies target attributes within the digital content and takes this information into consideration when determining which editing tools to retrieve and present to the user. Such target attributes may include, for example and without limitation, zooming/panning motion by the camera, the identification of one or more faces, fast motion by objects, segments with poor lighting, poor contrast levels, video shaking within the content, video shaking by the camera, and so on.

To illustrate, suppose that the digital content analyzer 108 identifies a target attribute corresponding to poor lighting in the digital content. Based on the presence of this particular target attribute (poor lighting), one or more corresponding editing tools are retrieved. For this particular example, one or more editing tools comprising lighting adjustment tools may be retrieved for allowing the user to incorporate better lighting into the digital content. As another example, suppose that the digital content analyzer 108 identifies a target attribute corresponding to a shaking effect within the digital content. For this particular example, one or more editing tools comprising video stabilization tools may be retrieved for allowing the user to address the shaking effect exhibited by the digital content. As yet another example, suppose that the digital content analyzer 108 identifies a target attribute corresponding to the presence of an individual's face within the digital content. For this particular example, one or more editing tools comprising motion tracking tools, object tracking tools, etc. may be retrieved for allowing the user to edit the individual's face within the digital content.

The cloud computing device 1002 may comprise a server computer or any other system providing computing capability. Alternatively, a plurality of computing devices may be employed that are arranged, for example, in one or more server banks or computer banks or other arrangements. For example, cloud computing device 1002 may comprise a cloud computing resource, a grid computing resource, and/or any other distributed computing arrangement. Such computing devices may be located in a single installation or may be distributed among many different geographical locations.

Similar to the arrangement shown for the media editing device 102 in

FIG. 1, the cloud computing device 1002 may include an effects applicator 1004, where the effects applicator 1004 further comprises a tools retriever 1006, a digital content analyzer 1008, a peripheral interface 1014, and a user interface generator 1012. The digital content analyzer 1008 further comprises a target attributes identifier 1010, and the user interface generator 1012 further comprises a user behavior monitor 1015. A data store 1011 maintained by the cloud computing device 1002 stores such data as one or more groupings of pre-defined target attributes, data regarding past user behavior, and so on. Digital content may be obtained directly by the cloud computing device 1002 via a peripheral interface 1014. Alternatively, digital content may be captured remotely at a client device 1019 and obtained by the cloud computing device 1002.

In the networked environment shown, the client device 1019 is coupled to the cloud computing device 1002 via a network 1018, such as the Internet or a local area network (LAN). The client device 1019 may be embodied as a computing device equipped with digital content recording capabilities such as, but not limited to, a digital camera, a smartphone, a tablet computing device, a digital video recorder, a laptop computer coupled to a webcam, and so on. A user interface for displaying suggested editing tools is displayed locally at the client device 1019.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

At least the following is claimed:

1. A method implemented in a media editing device for editing an image, comprising:
retrieving digital content;
analyzing the digital content;
searching for a plurality of target attributes in the digital content, the plurality of target attributes being grouped into different categories, the different categories having corresponding editing tools;
based on identification of at least one target attribute in the digital content, retrieving at least one suggested editing tool in at least one category corresponding to the identified at least one target attribute; and
populating at least one toolbar in the user interface with the retrieved at least one suggested editing tool.

2. The method of claim 1, further comprising:
monitoring for usage of the at least one suggested editing tool by a user; and
logging usage of the at least one suggested editing tool by the user in the data store.

3. The method of claim 1, wherein retrieving the at least one suggested editing tool further comprises:
searching the data store for historical data regarding prior usage of editing tools in connection with the identified at least one target attribute; and
retrieving at least one suggested editing tool based on the prior usage.

4. The method of claim 3, wherein editing tools that were previously used are retrieved as suggested editing tools.

5. The method of claim 3, further comprising bypassing retrieval of editing tools that were previously retrieved and populated in the at least one toolbar but not used by the user.

6. The method of claim 3, wherein the historical data further identifies a user corresponding to the prior usage of the editing tools in connection with the identified at least one target attribute.

7. The method of claim 1, wherein retrieving the at least one suggested editing tool comprises retrieving a grouping of editing tools from the data store based on the identified at least one target attribute.

8. The method of claim 1, wherein retrieving the at least one suggested editing tool comprises retrieving a grouping of editing tools from the data store based on respective weight values assigned to each editing tool in the data store, wherein most recently used editing tools are assigned a higher relative weight value.

9. The method of claim 1, wherein the target attributes comprise at least two of: facial contour, eye color, nose shape, skin color, wrinkle, facial blemish, and facial feature size.

10. The method of claim 1, wherein the target attributes comprise at least two of: a threshold lighting level, a threshold contrast level, a presence of artifacts, zooming/panning motion within the digital content, a presence of camera shaking, a threshold level of detected motion, and a presence of speech within the digital content.

11. The method of claim 1, wherein searching for the plurality of target attributes in the digital content comprises analyzing a timeline representation of a presence and corresponding duration of each of a plurality of predetermined attributes exhibited by the digital content.

12. A system, comprising:
a memory storing instructions; and
a processor coupled to the memory and configured by the instructions to:
retrieve digital content;
analyze the digital content;
search for a plurality of target attributes in the digital content, the plurality of target attributes being grouped into different categories, the different categories having corresponding editing tools;
based on identification of the at least one target attribute in the digital content, retrieve at least one suggested editing tool in at least one category corresponding to the identified at least one target attribute; and
populate at least one toolbar in the user interface with the retrieved at least one suggested editing tool.

13. The system of claim 12, wherein the data store is implemented in a server communicatively coupled to the media editing device.

14. The system of claim 12, wherein the processor is further configured to:
monitor for usage of the at least one suggested editing tool by a user; and
log usage of the at least one suggested editing tool by the user in the data store.

15. The system of claim 12, wherein the processor retrieves the at least one suggested editing tool by performing the operations of:
searching the data store for historical data regarding prior usage of editing tools in connection with the identified at least one target attribute; and
retrieving at least one suggested editing tool based on the prior usage.

16. The system of claim 15, wherein editing tools that were previously used are retrieved as suggested editing tools.

17. The system of claim 15, wherein the processor is further configured to bypass retrieval of editing tools that were previously retrieved and populated in the at least one toolbar but not used by the user.

18. The system of claim 15, wherein the historical data further identifies a user corresponding to the prior usage of the editing tools in connection with the identified at least one target attribute.

19. The system of claim 12, wherein the processor retrieves the at least one suggested editing tool by retrieving a grouping of editing tools from the data store based on the identified at least one target attribute.

20. A non-transitory computer-readable storage medium having instructions stored thereon, wherein when executed by a processor, the instructions configure the processor to:
retrieve digital content depicting at least one individual;
analyze attributes of the at least one individual depicted in the digital content;
determine whether any of the analyzed attributes match at least one of a plurality of target attributes, the plurality of target attributes being grouped into different categories, the different categories having corresponding editing tools;
based on a match with at least one target attribute, retrieve at least one suggested editing tool in at least one category corresponding to the identified at least one target attribute; and
populate at least one toolbar in the user interface with the retrieved at least one suggested editing tool.

21. The computer-readable medium of claim 20, wherein the analyzed attributes comprise facial features of the at least one individual.

22. The computer-readable medium of claim 20, wherein the data store is implemented in a server communicatively coupled to the media editing device.

23. The computer-readable medium of claim 20, wherein the processor is further configured to:
monitor for usage of the at least one suggested editing tool by a user; and
log usage of the at least one suggested editing tool by the user in the data store.

24. The computer-readable medium of claim 20, wherein the processor retrieves the at least one suggested editing tool by performing the operations of:
searching the data store for historical data regarding prior usage of editing tools in connection with the identified at least one target attribute; and
retrieving at least one suggested editing tool based on the prior usage.
